(19) United States
(12) Patent Application Publication
(10) Pub. No.: US 2009/0311566 A1
(43) Pub. Date: Dec. 17, 2009

(54) SEPARATING PLATE FOR FUEL CELL STACK AND METHOD OF MANUFACTURING THE SAME

(75) Inventors: Sae Hoon Kim, Gyeonggi-do (KR); Yoo Chang Yang, Gyeonggi-do (KR); Sung Ho Lee, Gyeonggi-do (KR); Jung Do Suh, Seoul (KR); Byung Ki Ahn, Gyeonggi-do (KR); Tae Won Lim, Seoul (KR); Dai Gil Lee, Daejeon (KR); Seong Su Kim, Gyeongsangnam-do (KR); Ha Na Yu, Gyeongsangbuk-do (KR); In Uk Hwang, Gyeonggi-do (KR); Byoung Chul Kim, Daejeon (KR); Kwan Ho Lee, Daejeon (KR); Soon Ho Yoon, Incheon (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Korea Advanced Institute of Science and Technology, Daejeon (KR)

(21) Appl. No.: 12/394,337

(22) Filed: Feb. 27, 2009

(30) Foreign Application Priority Data
Jun. 12, 2008 (KR) 10-2008-0055008

(51) Int. Cl. H01M 8/04

(52) U.S. Cl. 429/26; 29/623.3

(57) ABSTRACT

The present invention provides a separating plate for a fuel cell stack and method of manufacturing the same, and more particularly, to a separating plate for a fuel cell stack and method of manufacturing the same, in which the separating plate constituting the fuel cell stack is formed in such a fashion as to interpose an array of metal pipes between two sheets of composite material, and a gasket abutting against the separating plate is formed in such a fashion as to define hydrogen and air flow channels, thereby removing a contact resistance between two adjoining separating plates constituting unit cells to improve the efficiency of the fuel cell.

### CROSS-REFERENCE TO RELATED APPLICATION

This application claims the benefit under 35 U.S.C. §119(a) of Korean Patent Application No. 10-2008-055008 filed on Jun. 12, 2008, the entire contents of which are incorporated herein by reference.

### BACKGROUND OF THE INVENTION

(a) Field of the Invention

The present invention relates to a separating plate for a fuel cell stack and method of manufacturing the same, and more particularly, to a separating plate for a fuel cell stack and method of manufacturing the same, in which the separating plate constituting the fuel cell stack is formed in such a fashion as to interpose an array of metal pipes between two sheets of composite material, and a gasket abutting against the separating plate is formed in such a fashion as to define hydrogen and air flow channels, thereby removing a contact resistance between two adjoining separating plates constituting unit cells to suitably improve the efficiency of the fuel cell.

(b) Background Art

A fuel cell is a zero-emission electric power generating device which directly converts chemical energy from hydrogen and oxygen into electrical energy through an electrochemical reaction. Fuel cells are classified into a phosphoric acid fuel cell (PAFC), alkaline fuel cell (AFC), polymer electrolyte (=proton exchange) membrane fuel cell (PEMFC), molten carbonate fuel cell (MCFC), solid oxide fuel cell (SOFC), direct methanol fuel cell (DMFC), and the like depending on the kind of an electrolyte used.

Among these fuel cells, the polymer electrolyte membrane fuel cell (PEMFC) is distinguished from other types of fuel cells in that its electrolyte consists of a solid polymer, not a liquid electrolyte. The polymer electrolyte membrane fuel cell (PEMFC) is operated at a low temperature of approximately 50-80° C., is relatively high in efficiency, current density and power density, and has a short start time and thus a rapid response characteristic according to a load change as compared to other types of fuel cells. Thus, the PEMFC can have a number of uses in various fields including, but not limited to, a power source of a zero-emission vehicle (ZEV), a self-generator, a portable power source, an army application power source and the like.

The structure of a typical polymer electrolyte fuel cell stack will be discussed hereinafter with reference to FIG. 1.

In general, a typical polymer electrolyte fuel cell stack 10 is a combination of a plurality of unit cells 11, each of which preferably includes a membrane electrode assembly (MEA) 12 positioned at the central portion thereof.

The membrane electrode assembly 12 preferably includes a solid polymer electrolyte membrane 13 through which protons can be emigrated, a fuel (hydrogen) electrode 14 as an suitable anode and an air electrode 15 as a suitable cathode with a thin catalyst layer coated on either side of the electrolyte membrane 13 and preferably interposed between the electrodes and the membrane to allow hydrogen and oxygen to react with each other by means of the catalyst layer.

In addition, the unit cell 11 preferably includes a gas diffusion layer (GLD) 16 and a gasket 17 which are sequentially stacked to either side of the membrane electrode assembly 12, respectively, and a separating plate 18 provided on the outer side of the gasket 17, the separating plate having flow channels formed therein so as to allow fuel or air to be supplied therethrough and water produced by the reaction of hydrogen as the fuel and oxygen from the air to be exhausted therethrough. Preferably, an end plate is joined to the outermost side of the unit cell so as to support the respective components.

In certain examples, the gasket 17 functions to hermetically seal the fuel or air flow channels formed in the separating plate so as to suitably prevent fuel or air from leaking to the outside.

The electric energy generating principle of the fuel cell stack as preferably constructed above will be discussed briefly hereinafter.

Preferably, the hydrogen oxidation reaction occurs at the fuel electrode 14 to suitably produce protons and electrons, which in turn migrate from the fuel electrode 14 to the air electrode 15 through the electrolyte membrane 13 and the separating plate 18, respectively. Thereafter, at the air electrode 15, an electrochemical reaction occurs in which the protons and electrons migrated to the air electrode from the fuel electrode suitably react with oxygen in the air supplied to the air electrode to thereby produce water. At this time, electric energy is suitably produced by the flow of the electrons between the fuel electrode 14 and the air electrode 15.

Accordingly, hydrogen supplied to the fuel electrode is suitably decomposed into protons (H⁺) and electrons (e−), at which time, the decomposed protons migrate from the fuel electrode 14 to the air electrode 15 through the electrolyte membrane 13. At the air electrode, the protons (H⁺) migrated thereto from the fuel electrode 14 and the electrons (e−) transported thereto from the fuel electrode 14 through an external conductive wire react with oxygen in the air suitably supplied thereto through an air supply unit to produce water and suitably generate heat and result in generation of electric energy.

Preferably, in such a polymer electrolyte membrane fuel cell stack 10, the separating plate 18 suitably serves to divide each individual unit cell 11 and simultaneously provide flow channels for fuel, air and cooling water.

Preferably, since it is required that the separating plate 18 have suitably low gas permeability, sufficient structural strength to maintain the shape of the unit cell 11, and have the reduced electrical contact resistance between the unit cells 11, the characteristics of the separating plate 18 have an influence on the performance of the entire fuel cell.

In the meantime, the construction of the separating plate of the unit cell in the fuel cell stack will be described hereinafter.

As shown in FIG. 2, the separating plate 18 preferably includes a channel section 24 formed on either side thereof and having hydrogen and air flow channels 20 and 22 which are independent fine channel structures, and a manifold section 6 formed at both ends of the channel section and having a plurality of manifolds for allowing hydrogen, air and cooling water to be supplied and exhausted therethrough.

In preferred embodiments, when two adjoining separating plates are stackingly bonded to each other, a cooling water flow channel is suitably defined therebetween.

In other preferred embodiments, when the two adjoining unit cells 11 of the fuel cell stack 10 are suitably stacked on each other, as shown in FIGS. 1 and 2, the separators 18 of the two adjoining unit cells 1 are suitably stackingly bonded to each other. In this case, a separating plate 18 of one side has air flow channels 22 formed on the outer surface thereof and a separating plate 18 of the other-side has hydrogen flow channels 20 formed on the outer surface thereof. Preferably, cooling water flow channels 28 are suitably defined between the bonded separating plates.

In preferred embodiments, the separating plate 18 of a conventional polymer electrolyte membrane fuel cell stack 10 having the above structure is suitably manufactured in such a fashion that a graphite sheet is machined to have flow channels formed thereon, a metal material such as a thin stainless steel is machined by a press-molding method, or a mixture of a polymer matrix and carbon particles or graphite particles is compression-molded.

According to particularly preferred embodiments, the separating plate of the fuel cell has excellent electrical conductivity and structural strength, low contact resistance and surface resistance, low gas permeability, corrosion resistance and the like. In other preferred embodiments, the separating plate is mass-produced, and is manufactured at suitably low cost for the purpose of commercialization of the fuel cell.

In the use of the conventional separating plates, when two separating plates are stacked on each other to suitably define cooling water flow channels therebetween, a contact resistance exists between the unit cells, between the separating plate having the hydrogen flow channels of the fuel electrode side and the separating plate having air flow channels of the air electrode side, leading to a suitable reduction in efficiency of the fuel cell.

The above information disclosed in the Background section is only for enhancement of understanding of the background of the invention and should not be taken as an acknowledgment or any form of suggestion that this information forms the prior art that is already known to a person skilled in that art.

### SUMMARY OF THE INVENTION

In one aspect, the present invention provides a separating plate for a fuel cell stack and method of manufacturing the same, in which the separating plate is suitably formed using a hot-press molding method in such a fashion as to integrally interpose an array of a plurality of metal pipes for cooling water flow channels, preferably between two sheets of filament composite material, thereby suitably removing a contact resistance between two adjoining separating plates contacting with each, wherein gaskets abutting against the separating plate are formed in such a fashion as to suitably define hydrogen and air flow channels of the separating plate, thereby suitably improving the efficiency of the fuel cell.

In one preferred aspect, the present invention provides a separating plate for a fuel cell stack, comprising a channel section preferably including a plurality of cooling water flow channels penetratingly formed therein, a plurality of hydrogen flow channels formed on one outer surface thereof and a plurality of air flow channels formed on the other outer surface thereof, the hydrogen flow channels and the air flow channels preferably being alternately arranged with the cooling water flow channels in such a fashion as to suitably confront each other; an introduction section integrally suitably formed at one end thereof with both ends of the channel section, respectively, and having an inner space formed therein so as to fluidically communicate with each of the plurality of cooling water flow channels; and a manifold section integrally formed with the other end of the introduction section and having cooling water inlet and outlet manifolds, wherein a partitioning plate is preferably disposed between the manifold section and the introduction section so as to suitably divide cooling water inlet and outlet manifolds of the manifold section and the inner space of the introduction section, the partitioning plate having cooling water inlets and cooling water outlets penetratingly formed therein.

In a preferred embodiment, the channel section, the introduction section and the manifold section are integrally molded with each other by means of a composite material which is any one selected from, but not limited to, a carbon fiber prepreg using a thermoplastic and thermosetting resin as a matrix, and a polymer containing a conductive carbon fiber, a carbon black, graphite particles and metal particles.

In another preferred embodiment, an elongated hollow member which is any one selected from, but not limited to, a metal pipe, a composite material pipe and a PVC pipe is preferably inserted into each of the cooling water flow channels.

In another aspect, the present invention provides a method of manufacturing a separating plate for a fuel cell stack, the method preferably comprising the steps of providing two sheets of composite material which have undergone a slitting and cutting process to suitably conform to a desired size of the separating plate and is in a semi-cured state; seating the two sheets of composite material and a plurality of elongated hollow members equidistantly spaced therebetween on the obverse surface of a lower-half mold of a hot press, the obverse surface having a concavo-convex section 38 for formation of hydrogen or air flow channels; lowering the an upper-half mold of the hot press, whose reverse surface has a concavo-convex section for formation of hydrogen or air flow channels toward the lower-half mold, and then integrally boning the two sheets of composite material to each other into a single sheet of composite material while preferably pressing and simultaneously curing them by means of a high-temperature press process; and removing from the upper-half mold and the lower-half mold a separate plate fabricated in such a fashion that the hydrogen and air flow channels are formed on both outer surfaces of the single sheet of composite material, respectively, and simultaneously, the inner spaces of the elongated hollow members embedded in the single sheet of composite material define the cooling water flow channels.

In yet another aspect, the present invention provides a method of manufacturing a separating plate for a fuel cell stack, the method preferably comprising the steps of providing two sheets of composite material which have undergone a slitting and cutting process to conform to a desired size of the separating plate and is in a semi-cured state; seating the two sheets of composite material and a plurality of inserts equidistantly spaced therebetween on the obverse surface of a lower-half mold of a hot press, the obverse surface having a concavo-convex section 38 for formation of hydrogen or air flow channels and the inserts being provided for formation of cooling water flow channels; lowering the an upper-half mold of the hot press, whose reverse surface has a concavo-convex section for formation of hydrogen or air flow channels toward the lower-half mold, and then integrally boning the two sheets of composite material to each other into a single sheet of composite material while pressing and simultaneously curing them by means of a high-temperature press process; removing from the upper-half mold and the lower-half mold a separate plate fabricated in such a fashion that the hydrogen and air flow channels are formed on both outer surfaces of the single sheet of composite material, respectively, with the inserts embedded in the single sheet of composite material; and removing the inserts embedded in the single sheet of composite material so as to allow the corresponding portions from which the inserts are removed to define the cooling water flow channels.

In a preferred embodiment, the each insert may be suitably fabricated of a material which is dissolved or decomposed in a specific solvent, or a material having a melting point of 200 C or less.

In another preferred embodiment, if the insert is fabricated of the material which is dissolved or decomposed in the specific solvent, the step of integrally boning the two sheets of composite material to each other may preferably further include a step of removing the inserts by separately dissolving or decomposing the inserts in the specific solvent.

In another preferred embodiment, if the insert is suitably fabricated of the material having a melting point of 200 C or less, it may be preferably removed by being melted in the step of integrally boning the two sheets of composite material to each other.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

FIG. 1 is a schematic cross-sectional view illustrating the construction of a fuel cell stack;

FIG. 2 is a view illustrating the structure of a conventional separating plate according to the prior art;

FIGS. 3 and 4 are perspective views illustrating a separating plate manufacturing method according to the present invention;

FIG. 5 is a top plan view illustrating a separating plate according to the present invention;

FIG. 6 is a cross-sectional view taken along the line A-A of FIG. 5;

FIG. 7 is a cross-sectional view taken along the line B-B of FIG. 5;

FIG. 8 is a cross-sectional view taken along the line C-C of FIG. 5;

FIG. 9 is a perspective view illustrating a state in which a hydrogen-side gasket and an air-side gasket are in close contact with one side and the other side of a separating plate according to the present invention;

FIG. 10 is a top plan view illustrating a state in which a hydrogen-side gasket is in close contact with one side of a separating plate according to the present invention;

FIG. 11 is a top plan view illustrating a state in which an air-side gasket is in close contact with the other side of a separating plate according to the present invention;

FIG. 12 is a top plan view illustrating a state in which a hydrogen-side gasket and an air-side gasket are in close contact with a separating plate according to the present invention;

FIG. 13 is a cross-sectional view taken along the line D-D of FIG. 12;

FIG. 14 is a cross-sectional view taken along the line E-E of FIG. 12; and

FIG. 15 is a cross-sectional view taken along the line F-F of FIG. 12.

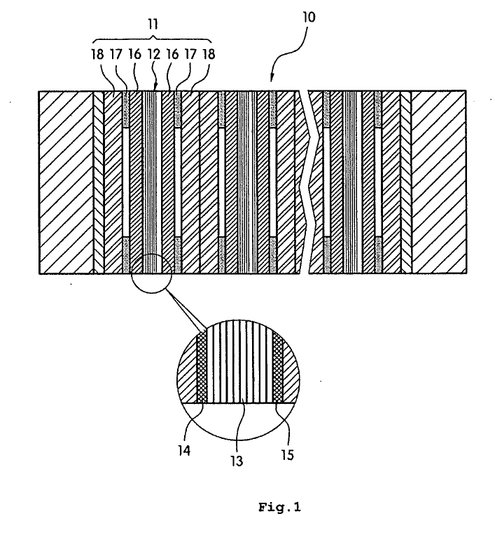

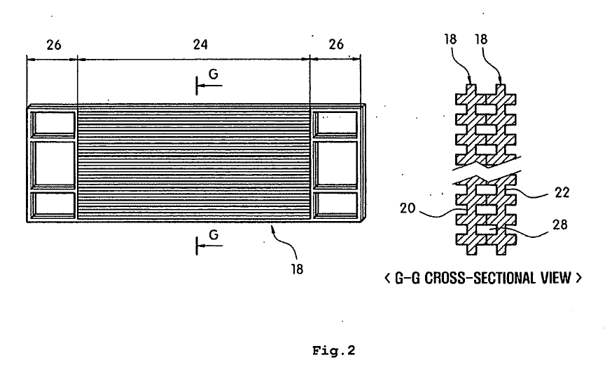

Reference numerals set forth in the Drawings includes reference to the following elements as further discussed below:

| | |
|---|---|
| 10: fuel cell stack | 11: unit cell |
| 12: membrane electrode assembly | |
| 13: electrolyte membrane | |
| 14: fuel electrode | 15: air electrode |
| 16: gas diffusion layer | 17: gasket |
| 18: separating plate | 20: hydrogen flow channel |
| 22: air flow channel | 24: channel section |
| 26: manifold section | 26a: air intake manifold |
| 26b: cooling water inlet manifold | |
| 26c: hydrogen intake manifold | 26d: air exhaust manifold |
| 26e: cooling water outlet manifold | |
| 26f: hydrogen exhaust manifold | 28: cooling water flow channel |
| 30: composite material | 32: elongated hollow member |
| 34: upper-half mold | 36: lower-half mold |
| 38: concave-convex section for | |
| formation of hydrogen or air flow | |
| channel | |
| 40: insert | 50: introduction section |
| 52: inner space | 54: partitioning plate |
| 56: cooling water inlet | 58: cooling water outlet |
| 60: hydrogen-side gasket | 62: air-side gasket |
| 60a, 60b, 62a, 62b: through-holes | |

### DETAILED DESCRIPTION

As described herein, the present invention includes a separating plate for a fuel cell stack, comprising a channel section including a plurality of cooling water flow channels penetratingly formed therein, a plurality of hydrogen flow channels formed on one outer surface thereof and a plurality of air flow channels formed on the other outer surface thereof, an introduction section integrally formed at one end thereof with both ends of the channel section, respectively; and a manifold section integrally formed with the other end of the introduction section and having cooling water inlet and outlet manifolds, wherein a partitioning plate is disposed between the manifold section and the introduction section, the partitioning plate having cooling water inlets and cooling water outlets penetratingly formed therein.

In one embodiment, the channel section, the hydrogen flow channels and the air flow channels are alternately arranged with the cooling water flow channels in such a fashion as to confront each other.

In another embodiment, the introduction section has an inner space formed therein so as to fluidically communicate with each of the plurality of cooling water flow channels.

In another further embodiment, the partioning plate is disposed so as to divide cooling water inlet and outlet manifolds of the manifold section and the inner space of the introduction section.

The invention also features a method of manufacturing a separating plate for a fuel cell stack, the method comprising the steps of providing two sheets of composite material seating the two sheets of composite material and a plurality of elongated hollow members equidistantly spaced therebetween on the obverse surface of a lower-half mold of a hot press, lowering the an upper-half mold of the hot press toward the lower-half mold, and then integrally boning the two sheets of composite material to each other into a single sheet of composite material while pressing and simultaneously curing them, removing from the upper-half mold and the lower-half mold a separate plate fabricated in such a fashion that the hydrogen and air flow channels are formed on both outer surfaces of the single sheet of composite material, respectively, and simultaneously, the inner spaces of the elongated hollow members embedded in the single sheet of composite material define the cooling water flow channels, or a separate plate fabricated in such a fashion that the hydrogen and air flow channels are formed on both outer surfaces of the single sheet of composite material, respectively, with the inserts embedded in the single sheet of composite material; and removing the inserts embedded in the single sheet of composite material wherein the corresponding portions from which the inserts are removed define the cooling water flow channels.

In one embodiment, the two sheets of composite material have undergone a slitting and cutting process to conform to a desired size of the separating plate.

In another embodiment, the two sheets of composite material are in a semi-cured state.

In still another embodiment, the obverse surface has a concavo-convex section for formation of hydrogen or air flow channels.

In another further embodiment, the inserts are provided for formation of cooling water flow channels.

In one embodiment, the reverse surface of the upper-half mold of the hot press has a concavo-convex section for formation of hydrogen or air flow channels.

In a further embodiment, the step of pressing and simultaneously curing them is carried out by means of a high-temperature press process.

The invention also features a motor vehicle comprising the separating plate for a fuel cell stack as described in any one of the embodiments or aspects herein.

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

Preferred embodiments according to the present invention will be described herein with reference to the accompanying drawings.

In preferred embodiments, the present invention features a separating plate suitably manufactured by using two composite material sheets and that in further preferred embodiments has hydrogen flow channels suitably formed on one outer surface thereof and air flow channels suitably formed on the other outer surface thereof, and pipe-like cooling water flow channels penetratingly formed therein, thereby removing the contact resistance between two adjoining unit cells. According to certain preferred embodiments of the invention, the separating plate suitably manufactured by using two composite material sheets as described herein is manufactured in order to solve the problem in that the efficiency of the fuel cell for generating electricity is reduced by the presence of the contact resistance between two adjoining unit cells due to formation of cooling water flow channels between the two separating plates according to the bonding of two separating plates, i.e., the contact resistance between the separating plate having the hydrogen flow channels of the fuel electrode side and the separating plate having the air flow channels of the air electrode side.

Accordingly, a method of manufacturing the separating plate is described hereinafter.

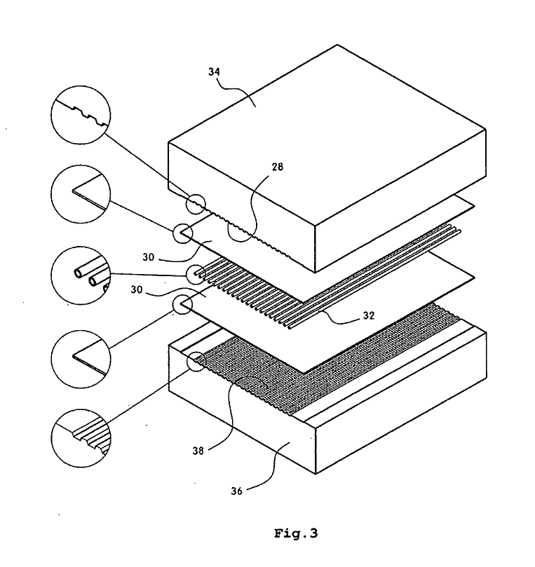

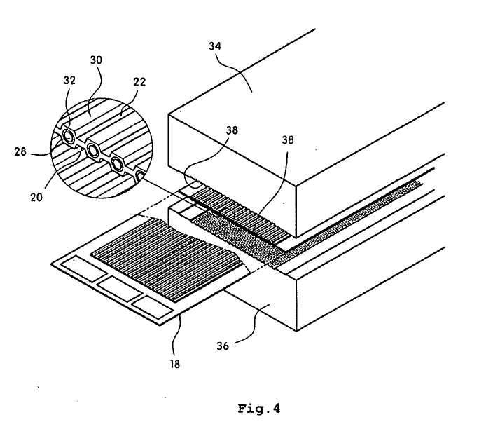

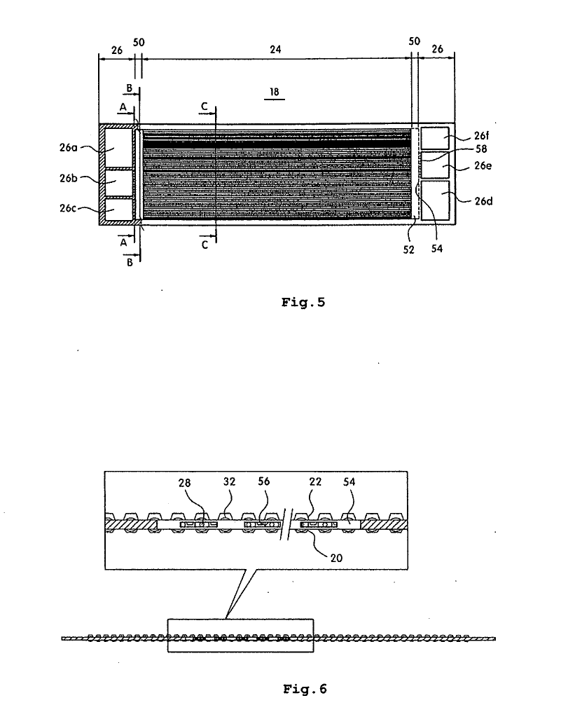

FIGS. 3 and 4 are perspective views illustrating a separating plate manufacturing method according to preferred embodiments of the present invention. FIG. 5 is a top plan view illustrating an exemplary separating plate according to certain preferred embodiments of the present invention.

In one embodiment, two sheets of composite material 30 are preferably provided which have undergone a slitting and cutting process to suitably conform to a desired size of the separating plate and is in a semi-cured state. Each sheet of composite material 30 may be preferably provided in a state where several raw material sheets are suitably overlapped with each other depending on the thickness of the separating plate.

Preferably, the composite material 30 may employ a carbon fiber prepreg using, for example, a thermoplastic and thermosetting resin as a matrix, or a polymer containing a conductive carbon fiber, a carbon black, graphite particles and metal particles.

In other further embodiments, an array of a plurality of elongated hollow members 32 is suitably disposed between the two sheets of composite material 30. According to further embodiments, each of the elongated hollow members 32 preferably uses a metal pipe having a fine diameter such as that of a needle, and may preferably use a composite material pipe, PVC pipe, and the like besides the metal pipe.

According to other certain embodiments, the thus-provided two sheets of composite material 30 and elongated hollow members 32 are suitably disposed in a hot press.

In other preferred embodiments of the invention, an upper-half mold 34 of the hot press has a concavo-convex section 38 suitably formed on the reverse surface thereof for formation of hydrogen or air flow channels, and a lower-half mold 36 of the hot presses has a concavo-convex section 38 suitably formed on the obverse surface thereof for formation of hydrogen or air flow channels.

In certain exemplary embodiments, if the concavo-convex section 38 formed on the reverse surface of the upper-half mold 34 of the hot press is preferably selected as one for formation of hydrogen flow channel, the concavo-convex section 38 formed on the obverse surface of the lower-half mold 34 of the hot press is reversely selected as one for formation of air flow channel.

In further embodiments, the two sheets of composite material 30 and a plurality of elongated hollow members 32 equidistantly spaced therebetween are preferably seated on the obverse surface of the lower-half mold 36 of the hot press having the concavo-convex section 38 for formation of hydrogen or air flow channels.

According to still further embodiments, the upper-half mold 34 of the hot press having the concavo-convex section 38 for formation of hydrogen or air flow channels is suitably lowered toward the lower-half mold 36, and then the two sheets of composite material 30 are suitably pressed into a mold at high temperature by the hot press.

Preferably, the two sheets of composite material 30 in the semi-cured state are integrally boned to each other into a single sheet of composite material 30 while being suitably pressed and simultaneously cured by means of the above high-temperature press process.

Accordingly, the hydrogen and air flow channels 20 and 22 having a concavo-convex shape are suitably formed on both outer surfaces of the single sheet of composite material 30, respectively. Simultaneously, the inner spaces of the elongated hollow members 32 embedded in the single sheet of composite material 30 define cooling water flow channels 20 to thereby complete a separating plate 18.

Preferred methods of manufacturing the separating plate according to another embodiment of the present invention will be described hereinafter.

In one embodiment, two sheets of composite material 30 are preferably provided which have undergone a slitting and cutting process to conform to a desired size of the separating plate and are preferably in a semi-cured state.

In preferred embodiments, an array of a plurality of inserts 40 for formation of cooling water flow channels is suitably disposed between the two sheets of composite material 30.

Preferably, each insert 40 is fabricated of a material which is suitably dissolved in a solvent, preferably a specific solvent, such as a cellulose soluble in a solvent, for example, but not limited to, water, or a material such as sulfur, a thermoplastic polymer, metal or the like having a melting point of 200 C or less.

According to further embodiments, the two sheets of composite material 30 and a plurality of inserts 40 that are preferably equidistantly spaced therebetween for formation of cooling water flow channels are suitably seated on the obverse surface of the lower-half mold 36 of the hot press having the concavo-convex section 38 for formation of hydrogen or air flow channels.

In still further embodiments, the upper-half mold 34 of the hot press having the concavo-convex section 38 for formation of hydrogen or air flow channels is suitably lowered toward the lower-half mold 36, and then the two sheets of composite material 30 are pressed into a mold at high temperature by the hot press, such that the two sheets of composite material 30 in the semi-cured state are preferably integrally boned to each other into a single sheet of composite material 30 while being suitably pressed and simultaneously cured by means of the above high-temperature press process

Accordingly, in further embodiments, the hydrogen and air flow channels 20 and 22 are preferably formed on both outer surfaces of the single sheet of composite material 30, respectively, and simultaneously, a separating plate having the inserts 40 embedded therein is provisionally completed.

In further embodiments, the inserts 40 embedded in the separating plate are preferably removed, and the corresponding portions from which the inserts are removed suitably define the cooling water flow channels 28 to thereby finally complete the separate plate 18.

In further embodiments, a method of removing the inserts 40 is performed in such a fashion such that if each insert is suitably fabricated of a material which is dissolved or decomposed in the specific solvent, for example, but not limited to, a cellulose, it is caused to be dissolved in water, and if the insert is fabricated of a material having a melting point of 200 C or less, it is suitably removed by being melted as it is in the step of integrally boning the two sheets of composite material to each other.

Accordingly, a separate plate 18 is completed in which the cooling water flow channels 28 are suitably formed at the corresponding portions from the inserts 40 and are preferably removed in the single sheet of composite material 30, and the hydrogen and air flow channels 20 and 22 of a concavo-convex shape are suitably formed on both outer surfaces of the single sheet of composite material 30.

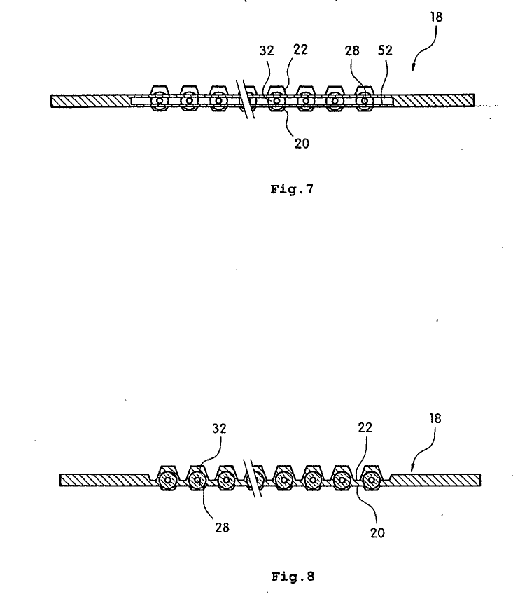

According to the invention as described herein, the separating plate manufactured according to the above embodiments has been described with reference to the preferred construction including the cooling water flow channels, the air flow channels, the hydrogen flow channels, wherein the introduction sections 50 and the manifold sections 26 are suitably integrally formed with both ends of the channel section 24 by using the same composite material as that of the channel section, described hereinafter with reference to exemplary FIGS. 6 to 8.

According to certain preferred embodiments, the introduction sections 50 are integrally formed at one end thereof with both ends of the channel section 24, and preferably have an inner space 52 formed therein so as to fluidically communicate with each of the cooling water flow channels 28.

According to preferred embodiments, the inner space 52 is formed as follows: if a mandrel (not shown) is suitably inserted into the two sheets of composite material before the press-molding and then it is removed after the press-molding, a portion where the mandrel is removed is a cavity, which is the inner space 51 fluidically communicating with the cooling water flow channels 28.

Preferably, the manifold sections 26 are integrally formed with the other end of the introduction section 50. In certain embodiments, the manifold section on one side preferably includes an air intake manifold 26a, a cooling water inlet manifold 26b and a hydrogen intake manifold 26c, which are penetratingly formed therein. In other certain embodiment, the manifold section on the other side preferably includes an air exhaust manifold 26d, a cooling water outlet manifold 26e and a hydrogen exhaust manifold 26f, which are penetratingly formed therein.

According to preferred embodiments of the invention, a partitioning plate 54 is preferably disposed between the manifold section 26 and the introduction section 50 so as to suitably divide cooling water inlet and outlet manifolds 26b and 26e of the manifold section 26 and the inner space 52 of the introduction section 50. Preferably, the partitioning plate has a plurality of cooling water inlets and outlets 56 and 58 penetratingly formed therein.

In certain preferred embodiments, the cooling water flow channels 28 suitably formed in the channel section 24 of the separating plate 18 fluidically communicate with the inner space 52 of the introduction section 50, and the inner space 52 of the introduction section 50 and the cooling water inlet and outlet manifolds 26b and 26e of the manifold section 26 fluidically communicate with each other via the plurality of cooling water inlets and outlets 56 and 58 suitably formed in the partitioning plate 54.

Accordingly, in preferred embodiments as described by the above configuration, cooling water sequentially flows in the order of the cooling water inlet manifold 26b of the manifold section 26, the plurality of cooling water inlets 56 formed in the partitioning plate 54 on one side, the inner space 52 formed in the introduction section 50 on one side, the cooling water flow channels 28 (for example, metal pipes) of the channel section 24, the inner space 52 formed in the introduction section 50 on the other side, the plurality of cooling water outlet 58 formed in the partitioning plate 54 on the other side, and the cooling water outlet manifold 26e of the manifold section 26.

A structure in which the gaskets come into close contact with the separating plate according to preferred embodiments of the present invention will be discussed hereinafter.

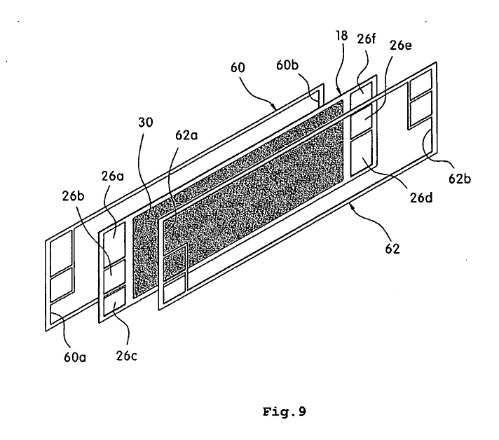

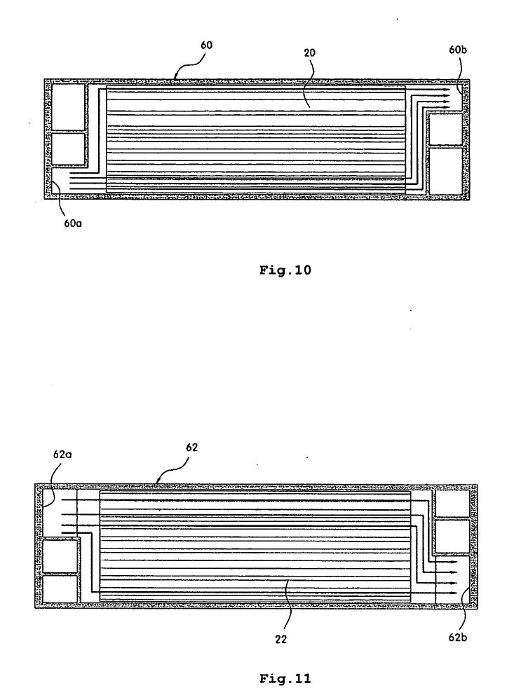

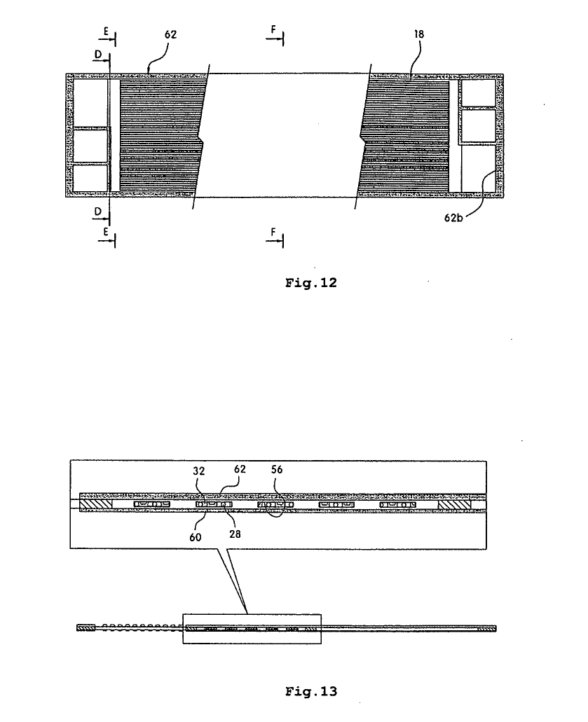

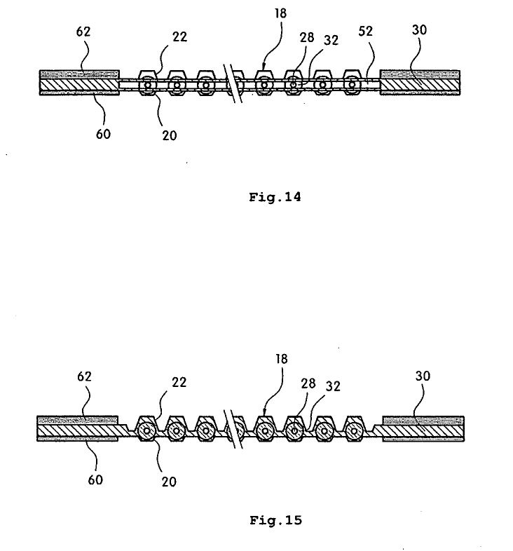

FIGS. 9 to 15 are views illustrating a state in which a hydrogen-side gasket and an air-side gasket are in close contact with one side and the other side of a separating plate according to the present invention.

In preferred embodiments, when the separating plate 18 according to the present invention is assembled to the fuel cell stack, the hydrogen-side gasket 60 and the air-side gasket 62 come into suitably close contact with the hydrogen flow channels 20 of a concavo-convex shape formed on one outer surface of the separating plate 18 and the air flow channels 22 of a concavo-convex shape formed on the other outer surface of the separating plate 18 to thereby form the hydrogen flow channels and the air flow channels in a substantially tightly sealed state.

Preferably, each of the hydrogen-side gasket 60 and the air-side gasket 62 has a plurality of through-holes formed at both ends thereof so as to suitably correspond to the air intake manifold 26a, the cooling water inlet manifold 26b and the hydrogen intake manifold 26c formed one end of the separating plate 18 and the air exhaust manifold 26d, and the cooling water outlet manifold 26e and the hydrogen exhaust manifold 26f formed on the other end of the separating plate 18, respectively.

Accordingly, in certain preferred embodiments, among the through-holes of the hydrogen-side gasket 60, the through-holes 60a and 60b corresponding to the hydrogen intake manifold 26c and the hydrogen exhaust manifold 26f of the separating plate 18 are preferably opened toward the introduction section 50, such that hydrogen sequentially flows in the order of the hydrogen intake manifold 26c, the through-hole 60a, the outer surface of the introduction section 50 on one side, the hydrogen flow channels 20 of the channel section 24, the outer surface of the introduction section 50 on the other side, the through-hole 60b, and the hydrogen exhaust manifold 26f.

Further, among the through-holes of the air-side gasket 62, the through-holes 62a and 62b corresponding to the air intake manifold 26a and the air exhaust manifold 26d of the separating plate 18 are preferably opened toward the introduction section 50, such that air sequentially flows in the order of the air intake manifold 26a, the through-hole 62a, the outer surface of the introduction section 50 on one side, the air flow channels 24 of the channel section 24, the outer surface of the introduction section 50 on the other side, the through-hole 62b, and the air exhaust manifold 26d.

Thus, according to the invention described herein, when the hydrogen and air-side gaskets 60 and 62 having improved structure are preferably stakingly boned to the separating plate 18 according to the present invention, the hydrogen flow channels and the air flow channels are easily formed in a substantially tightly sealed state.

In further preferred embodiments of the invention described herein, the channel section, the introduction section and the manifold section constituting the separating plate are suitably integrally molded with each other using a composite material in such a fashion that hydrogen and air flow channels are preferably formed on both outer surfaces of the channel section, and simultaneously pipe-like cooling water flow channels are formed in the channel section. According to further embodiments, the hydrogen flow channels and the air flow channels are preferably defined in a tightly sealed state by means of the gaskets, such that the contact resistance between two adjoining unit cells occurring due to formation of cooling water flow channels between the two separating plates according to the bonding of two separating plates, i.e., the contact resistance between the separating plate having the hydrogen flow channels of the fuel electrode side and the separating plate having the air flow channels of the air electrode side can be suitably removed unlike the conventional separating plate to improve the efficiency of the fuel cell.

In further preferred embodiments, the channel section, the introduction section and the manifold section constituting the separating plate are suitably formed by a single process, thereby enabling mass-production at low cost and contributing to commercialization of the fuel cell.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A separating plate for a fuel cell stack, comprising:
a channel section including a plurality of cooling water flow channels penetratingly formed therein, a plurality of hydrogen flow channels formed on one outer surface thereof and a plurality of air flow channels formed on the other outer surface thereof, the hydrogen flow channels and the air flow channels being alternately arranged with the cooling water flow channels in such a fashion as to confront each other;
an introduction section integrally formed at one end thereof with both ends of the channel section, respectively, and having an inner space formed therein so as to fluidically communicate with each of the plurality of cooling water flow channels; and
a manifold section integrally formed with the other end of the introduction section and having cooling water inlet and outlet manifolds,
wherein a partitioning plate is disposed between the manifold section and the introduction section so as to divide cooling water inlet and outlet manifolds of the manifold section and the inner space of the introduction section, the partitioning plate having cooling water inlets and cooling water outlets penetratingly formed therein.

2. The separating plate according to claim 1, wherein the channel section, the introduction section and the manifold section are integrally molded with each other by means of a composite material which is any one selected from a carbon fiber prepreg using a thermoplastic and thermosetting resin as a matrix, and a polymer containing a conductive carbon fiber, a carbon black, graphite particles and metal particles.

3. The separating plate according to claim 1, wherein a elongated hollow member is inserted into each of the cooling water flow channels of the channel section.

4. The separating plate according to claim 3, wherein the elongated hollow member is any one selected from a metal pipe, a composite material pipe and a PVC pipe.

5. A method of manufacturing a separating plate for a fuel cell stack, the method comprising the steps of:
providing two sheets of composite material which have undergone a slitting and cutting process to conform to a desired size of the separating plate and is in a semi-cured state;
seating the two sheets of composite material and a plurality of elongated hollow members equidistantly spaced therebetween on the obverse surface of a lower-half mold of a hot press, the obverse surface having a concavo-convex section for formation of hydrogen or air flow channels, or seating the two sheets of composite material and a plurality of inserts equidistantly spaced therebetween on the obverse surface of the lower-half mold of the hot press, the inserts being provided for formation of cooling water flow channels;
lowering the an upper-half mold of the hot press, whose reverse surface has a concavo-convex section for formation of hydrogen or air flow channels toward the lower-half mold, and then integrally boning the two sheets of composite material to each other into a single sheet of composite material while pressing and simultaneously curing them by means of a high-temperature press process;
removing from the upper-half mold and the lower-half mold a separate plate fabricated in such a fashion that the hydrogen and air flow channels are formed on both outer surfaces of the single sheet of composite material, respectively, and simultaneously, the inner spaces of the elongated hollow members embedded in the single sheet of composite material define the cooling water flow channels, or a separate plate fabricated in such a fashion that the hydrogen and air flow channels are formed on both outer surfaces of the single sheet of composite material, respectively, with the inserts embedded in the single sheet of composite material; and
removing the inserts embedded in the single sheet of composite material so as to allow the corresponding portions from which the inserts are removed to define the cooling water flow channels.

6. The method according to claim 5, wherein the each insert is fabricated of a material which is dissolved or decomposed in a specific solvent, or a material having a melting point of 200 C or less.

7. The method according to claim 5, wherein if the insert is fabricated of the material which is dissolved or decomposed in the specific solvent, the step of integrally boning the two sheets of composite material to each other further comprises a step of removing the inserts by separately dissolving or decomposing the inserts in the specific solvent.

8. The method according to claim 5, wherein if the insert is fabricated of the material having a melting point of 200 C or less, it is removed by being melt in the step of integrally boning the two sheets of composite material to each other.

9. The method according to claim 6, wherein if the insert is fabricated of the material which is dissolved or decomposed in the specific solvent, the step of integrally boning the two sheets of composite material to each other further comprises a step of removing the inserts by separately dissolving or decomposing the inserts in the specific solvent.

10. The method according to claim 6, wherein if the insert is fabricated of the material having a melting point of 200° C. or less, it is removed by being melt in the step of integrally boning the two sheets of composite material to each other.

11. A separating plate for a fuel cell stack, comprising:
a channel section including a plurality of cooling water flow channels penetratingly formed therein, a plurality of hydrogen flow channels formed on one outer surface thereof and a plurality of air flow channels formed on the other outer surface thereof;
an introduction section integrally formed at one end thereof with both ends of the channel section, respectively; and
a manifold section integrally formed with the other end of the introduction section and having cooling water inlet and outlet manifolds,
wherein a partitioning plate is disposed between the manifold section and the introduction sections the partitioning plate having cooling water inlets and cooling water outlets penetratingly formed therein.

12. The separating plate for a fuel cell stack of claim 11, wherein in the channel section, the hydrogen flow channels and the air flow channels are alternately arranged with the cooling water flow channels in such a fashion as to confront each other.

13. The separating plate for a fuel cell stack of claim 11, wherein the introduction section has an inner space formed therein so as to fluidically communicate with each of the plurality of cooling water flow channels.

14. The separating plate for a fuel cell stack of claim 11, wherein the partioning plate is disposed so as to divide cooling water inlet and outlet manifolds of the manifold section and the inner space of the introduction section.

15. A method of manufacturing a separating plate for a fuel cell stack, the method comprising the steps of:
providing two sheets of composite material;
seating the two sheets of composite material and a plurality of elongated hollow members equidistantly spaced therebetween on the obverse surface of a lower-half mold of a hot press;
lowering the an upper-half mold of the hot press toward the lower-half mold, and then integrally boning the two sheets of composite material to each other into a single sheet of composite material while pressing and simultaneously curing them;
removing from the upper-half mold and the lower-half mold a separate plate fabricated in such a fashion that the hydrogen and air flow channels are formed on both outer surfaces of the single sheet of composite material, respectively, and simultaneously, the inner spaces of the elongated hollow members embedded in the single sheet of composite material define the cooling water flow channels, or a separate plate fabricated in such a fashion that the hydrogen and air flow channels are formed on both outer surfaces of the single sheet of composite material, respectively, with the inserts embedded in the single sheet of composite material; and
removing the inserts embedded in the single sheet of composite material wherein the corresponding portions from which the inserts are removed define the cooling water flow channels.

16. The method of manufacturing a separating plate for a fuel cell stack of claim 15, wherein the two sheets of composite material have undergone a slitting and cutting process to conform to a desired size of the separating plate.

17. The method of manufacturing a separating plate for a fuel cell stack of claim 15, wherein the two sheets of composite material are in a semi-cured state.

18. The method of manufacturing a separating plate for a fuel cell stack of claim 15, wherein the obverse surface has a concavo-convex section for formation of hydrogen or air flow channels.

19. The method of manufacturing a separating plate for a fuel cell stack of claim 15, wherein the inserts are provided for formation of cooling water flow channels.

20. The method of manufacturing a separating plate for a fuel cell stack of claim 15, wherein the reverse surface of the upper-half mold of the hot press has a concavo-convex section for formation of hydrogen or air flow channels.

21. The method of manufacturing a separating plate for a fuel cell stack of claim 15, wherein the step of pressing and simultaneously curing them is carried out by means of a high-temperature press process.

22. A motor vehicle comprising the separating plate for a fuel cell stack of claim 1.

23. A motor vehicle comprising the separating plate for a fuel cell stack of claim 11.
